(19) United States
(12) Patent Application Publication
(10) Pub. No.: US 2016/0257228 A1
(43) Pub. Date: Sep. 8, 2016

(54) Multi-position travel pillow

(71) Applicants: Joshua Benjamin Lederer, Pittsburgh, PA (US); Laura Catherine West, Pittsburgh, PA (US)

(72) Inventors: Joshua Benjamin Lederer, Pittsburgh, PA (US); Laura Catherine West, Pittsburgh, PA (US)

(21) Appl. No.: 14/998,013

(22) Filed: Apr. 30, 2014

(51) Int. Cl. B60N 2/48; A47G 9/10

(52) U.S. Cl. CPC B60N 2/4879; A47G 9/1081

(57) ABSTRACT

A pillow has a pillow body and two ends. The pillow body has a generally rounded spiral shape which allows it to be wrapped around body parts, such as the neck and waist. It can also be compacted into a head pillow. The mulipositional and multifunctional nature of the pillow allows for compact storage and travel.

### BACKGROUND OF THE INVENTION

### Field of the Invention

The invention relates to a multi-position travel pillow.

### SUMMARY OF THE INVENTION

It is according an object of the invention to provide a multi-position travel pillow.

### BRIEF DESCRIPTION OF THE SEVERAL VIEWS OF THE DRAWING

FIG. 1 is a diagrammatic, top plan view of a travel pillow according to the invention;

FIG. 2 is a bottom view of the travel pillow;

FIG. 3 is a side view of the travel pillow;

FIG. 4 is a top plan view with an open strap;

FIG. 5 is a perspective view of the travel pillow wrapped around the user;

FIG. 6 is a perspective view of the travel pillow wrapped around the user;

FIG. 7 is a perspective view of the travel pillow;

FIG. 8 is a perspective view of the travel pillow wrapped around the user; and

FIG. 9 is a perspective view of the travel pillow wrapped around the user.

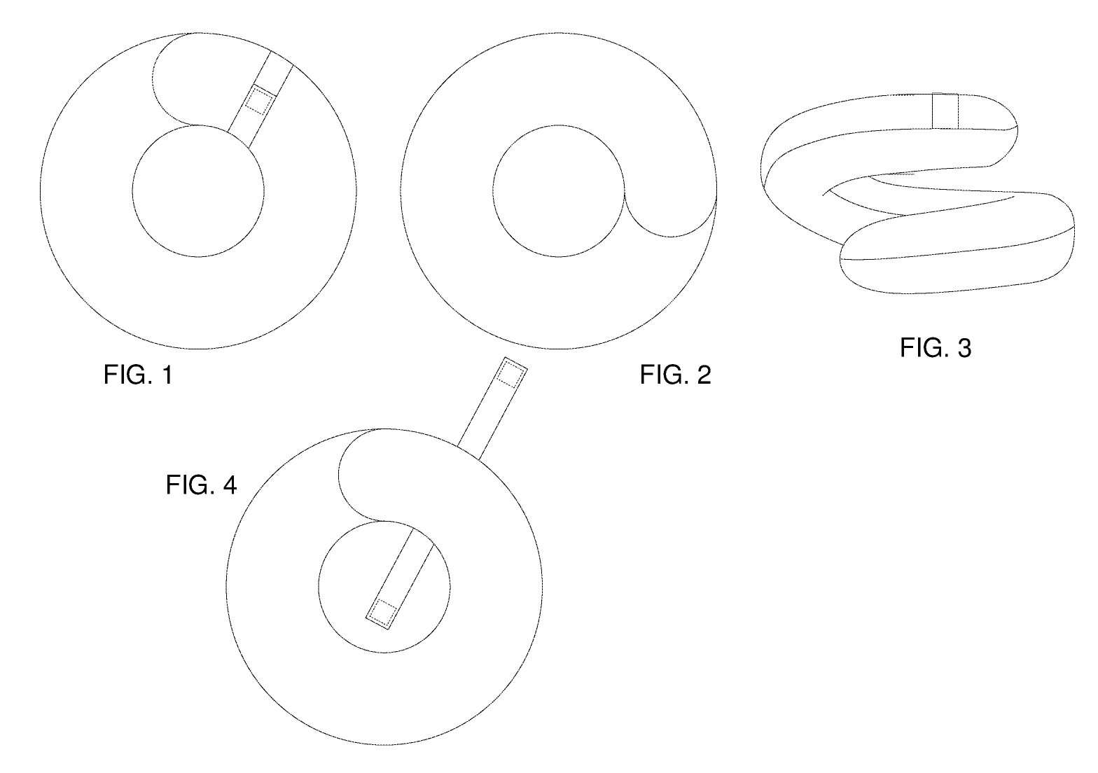

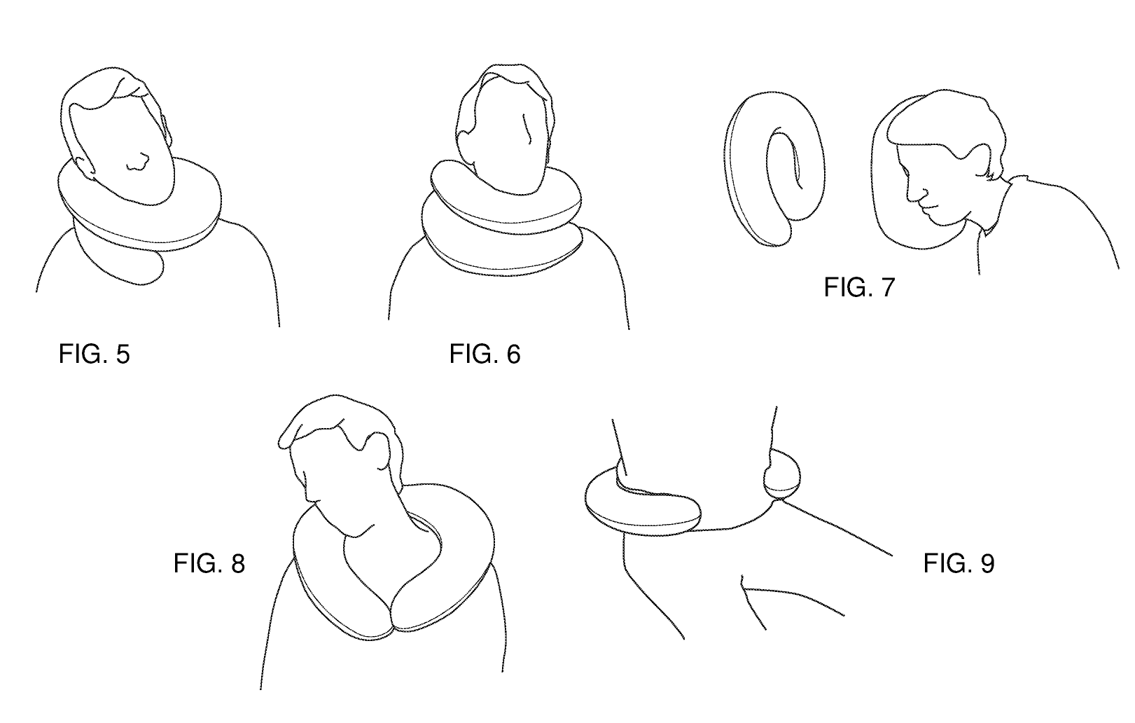

### DETAILED DESCRIPTION OF THE INVENTION

A pillow can be overlapped and secured with the integrated elastic strap to provide head support against the shoulder. The pillow can be overlapped and positioned under the chin to support the head and to prevent the head from nodding. The pillow can be flattened for use as a traditional pillow for propping the head against a wall. The pillow can be laid flat for use as a traditional airline pillow. The pillow can be wrapped around the torso to provide lumbar support. The round shaped and curved ends of the pillow create tension that allows the pillow to remain in place.

Passengers seated in airplanes, motor vehicles, trains, and other modes of transportation typically experience discomfort during long trips and often use travel pillows to provide cushioning and to support the head. There are a variety of pillow designs that attempt to cradle the head, support the head through inflatable bladders, wedge behind the neck, and so forth, however there is currently not a solution that allows for multi-position use for resting the head to one side, supporting the chin to prevent nodding or to use as a flat pillow in addition to providing the option for use as a secure lumbar support. In addition many travel pillows that attempt to solve the problem of head nodding are often bulky and cumbersome to transport and inefficient for shipping purposes.

The pillow consists of an exterior fabric covering (which can be made of a variety of materials including polyester fleece, spandex, cotton, nylon, polyurethane, etc.) with polyester batting or micro beads on the interior to provide cushioning. The pillow is constructed in a helical form factor which allows the open ends to overlap thereby creating a taller section that can be placed under the wearer's chin to prevent head nodding, placed over the shoulder to support the wearer's head, or laid flat to be used in the manner of a traditional pillow cushion. In addition the pillow can be wrapped around the wearer's waist or lower lumbar area and secures itself as the open ends wrap around the torso under fabric tension.

A closure tab (in the form of an elastic webbing or fabric strap with hook and loop or snap fastener) is used to secure the open ends of the pillow to prevent the overlapped pillow ends from sliding apart. The closure tab also can be used to ensure that the pillow will not become dislodged when the pillow is placed over the handle of a wheeled luggage bag for ease of transport.

1. A pillow, comprising:
a pillow body having two ends.
